(19) United States
(12) Patent Application Publication
(10) Pub. No.: US 2018/0018745 A1
(43) Pub. Date: Jan. 18, 2018

(54) LICENSING AS A SERVICE (LAAS)

(71) Applicant: salesforce.com, inc., San Francisco, CA (US)

(72) Inventors: Armand Glen Lisanti, Redmond, WA (US); James Morris, Lynnwood, WA (US); Joseph E. Downs, Edmonds, WA (US); Jun Huang, Seattle, WA (US); Matthew Small, San Francisco, CA (US); Nathan J. Horne, Walnut Creek, CA (US); Walter S. Harley, Seattle, WA (US)

(21) Appl. No.: 15/208,492

(22) Filed: Jul. 12, 2016

(51) Int. Cl. G06Q 50/18

(52) U.S. Cl. CPC G06Q 50/184; G06Q 2220/18

(57) ABSTRACT

Licensing as a service. A software package is downloaded from the app exchange in response to a download request. One or more licenses are received from a licensing entity by a client electronic device. The one or more licenses are maintained by the licensing entity for tenants of disparate heterogeneous cloud environments and provide the client electronic device authorization to utilize the software package. The licenses received from the licensing entity are assigned to one or more users within the client electronic device so that those users are granted access to the corresponding package. The client electronic device utilizes the software package with the one or more licenses as authorization.

### TECHNICAL FIELD

Embodiments relate to techniques for software licensing. More particularly, embodiments relate to techniques for providing licensing of applications and/or modules as a service to provide increased licensing flexibility.

### BACKGROUND

An app is a (typically) self-contained program or piece of software designed to fulfill a particular purpose. For example, an app can provide business analytics functionality, weather information, stock information, sales related information, etc. An app is generally downloaded by a user to a mobile (e.g., smartphone, tablet) device, but apps can be provided to non-mobile (e.g., desktop, kiosk) device or a web application provided by a web browser. The traditional mechanism for distributing apps is to provide a “store” or other exchange that allows a user to access a collection of apps. This is typically arranged where a user has an account and can purchase the apps through the account. These stores are typically designed to have the greatest possible audience in order to provide greater sales. Licensing is usually accomplished in an one-size-fits-all manner. That is, features are grantable by package licenses and applied the same way and through the same channel to each user who is granted access to the package.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a conceptual diagram of on-demand services environments that can provide access to an application exchange that can support and utilize license definition mechanisms.

FIG. 2 is a conceptual illustration of one embodiment of a technique to provide licensing as a service.

FIG. 3 is a conceptual illustration of one embodiment of a technique and architecture for supporting licensing as a service.

FIG. 4 illustrates a block diagram of an environment where an on-demand database service might be used.

FIG. 5 illustrates a block diagram of another environment where an on-demand database service might be used.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Cloud-based on-demand services environments provide a platform and/or services and functionality that can be shared and/or otherwise utilized by many different organizations and users. In order to make these environments useful for many different organizations and/or users, each of which have different expectations and needs, the environments are highly customizable. One component of this customization can be use of license definitions (LDs) that include one or more custom permissions that can be utilized to authorize components of the corresponding software package.

One strategy for managing license definitions is to store the license definition data (e.g., metadata) in one or more files (e.g., a markup language file, XML) and maintain the one or more files with a version control system (e.g., Perforce). In an environment having multiple platform/service instances, the license definitions should be deployed to each instance along with any corresponding app code. With this type of architecture, it is difficult for developers to bring new products to market because the entire platform must be redeployed to make the necessary changes. It also limits the parties that can license products through the environment because, for example, the people that have access to the version control system is typically limited.

Described herein are techniques and architectures to provide license definitions as a service, which makes creation and/or modification of the license definitions available to people outside of developers that have access the version control system. Also, license definitions can be updated without requiring redeployment of the platform, which eliminates platform release/update schedules. Thus, service/app providers can add new license definitions on their own schedules and not be constrained by platform administrators.

In various embodiments, license definitions are not organization-scoped like many other features/elements of the environment. Conceptually, license definitions can be thought of as service-level metadata to describe how a service can be bundled or sold.

Various embodiments of a licensing service hosted outside of the multitenant environment for providing license definitions that are functional within the multitenant environment and supports the features and functionality of apps and/or services within the multitenant environment as well as outside of the multitenant environment. In one embodiment, a licensing service existing outside of the multitenant environment core could be accessible from within and without the multitenant environment. This type of architecture would present few development restrictions.

In one embodiment, when the licensing service is hosted outside of the multitenant environment, communication between the licensing service is encrypted using, for example, Secure Sockets Layer (SSL) or Transport Layer Security (TLS) security protocols. SSL and TLS refer to cryptographic protocols that provide secure communications in an electronic network or environment. Various versions are available. Other security protocols can also be supported.

In one embodiment, hash-based message authentication (HMAC) can be utilized to process requests. HMAC is a message authentication code (MAC) that uses a hash function in combination with a cryptographic key. HMAC can be used to verify data integrity as well as authentication

License definitions are owned by the environment provider (aka Cloud Service Provider or CSP), however, providing license definitions as a service can open licensing management to other entities such as independent software vendors (ISVs).

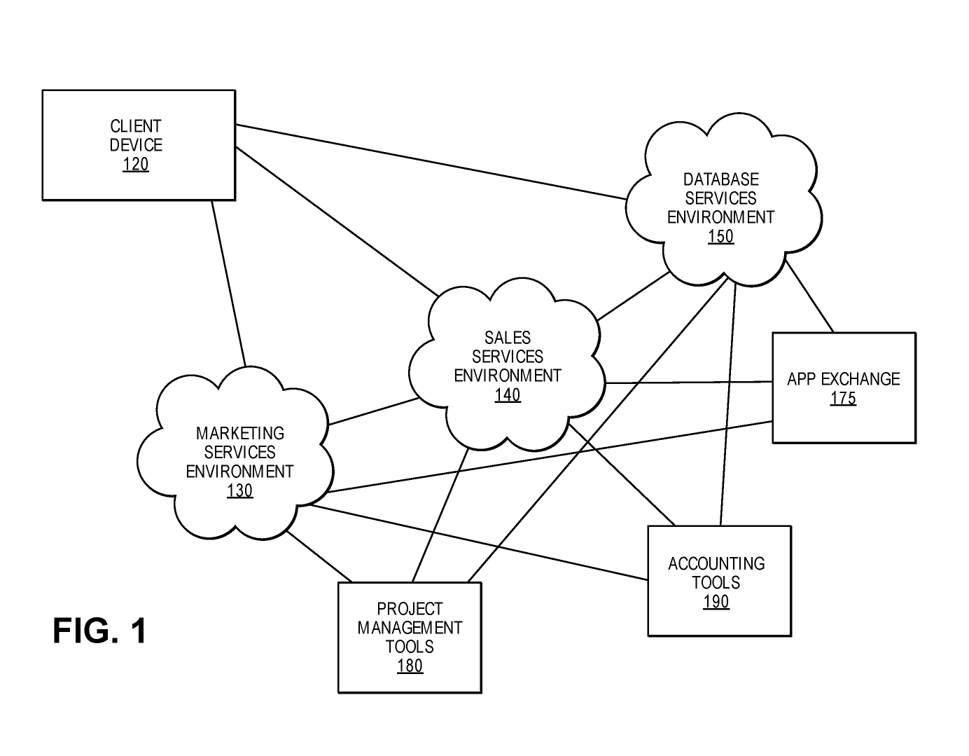

FIG. 1 is a conceptual diagram of on-demand services environments that can provide access to an application exchange that can support and utilize license definition mechanisms. The example of FIG. 1 is merely one of many configurations and environments in which an app exchange can be provided.

In one embodiment, a user may utilize client device 120 to access one or more of marketing services environment 130, sales services environment 140 and/or database services environment 150. In one embodiment each of marketing services environment 130, sales services environment 140 and/or database services environment 150 can be a multitenant on-demand services environment in which multiple tenants/organizations can have access to the environment while the data belonging to each tenant/organization is kept separate.

A tenant (or organization) includes a group of users who share a common access with specific privileges to a software instance. A multi-tenant architecture provides a tenant with a dedicated share of the software instance typically including one or more of tenant (or organization) specific data, user management, tenant-specific (organization-specific) functionality, configuration, customizations, non-functional properties, associated applications, etc. Multi-tenancy contrasts with multi-instance architectures, where separate software instances operate on behalf of different tenants.

Marketing services environment 130 can, for example, provide marketing services such as email campaigns, social media marketing and analysis, online campaign services, mobile campaign services as well as data and/or analytics and/or marketing automation. Sales services environment 140 can, for example, provide customer relationship management (CRM) services of various types. Database services environment 150 can, for example, be a multitenant database environment.

In one embodiment, an on-demand services environment utilizes tenant/organization identifiers (IDs) within the on-demand services environment to allow individual tenants/organizations to access their data while preserving the integrity of other tenant's/organization's data. In one embodiment, a multitenant database environment, for example, stores data for multiple client entities each identified by a tenant/organization ID having one of one or more users associated with the tenant/organization ID. Users of each of multiple client entities can only access data identified by a tenant/organization ID associated with their respective client entity. In one embodiment, the multitenant database is a hosted database provided by an entity separate from the client entities, and provides on-demand and/or real-time database service to the client entities.

Client device 120 can be any type of electronic device that can access resources over a network. For example, client device 120 can be a laptop computer system, a desktop computer system, a smartphone, a tablet, a wearable computing device, etc. Client device 120 can interact with other electronic devices over wired and/or wireless networks. Services provided by marketing services environment 130, sales services environment 140 and/or database services environment 150 can be supplemented by additional nodes/devices/services, for example project management tools 180 and/or accounting tools 190.

In one embodiment, client device 120 can access an app exchange via one or more of marketing services environment 130, sales services environment 140 and/or database services environment 150. In one embodiment, a user of client device 120 can utilize a single identity to access one or more of marketing services environment 130, sales services environment 140 and/or database services environment 150.

In one embodiment, app exchange 175 may be provided via any of the services environments to distribute any app, whether custom to the organization or not, via a central, app exchange. In one embodiment, the user experience in app exchange 175 can be personalized by a user's role within the organization, a user's department, a user's business unit, a user's preferred language and/or other relevant factors. The apps made available at the app exchange can be publicly available apps and/or custom developed apps.

In one embodiment, app exchange 175 can be configured to distribute web-based, mobile and/or desktop apps that can be deployed to mobile devices, tablets, desktop, laptop devices with a single user entity. In one embodiment, each organization can customize the app exchange experience for users belonging to the organization.

In one embodiment, the app exchange is accessed via a browser window, which provides a user access to the features of the app exchange. In one embodiment, the app exchange provides a search function that allows a user to search for apps by, for example, name, functionality, type and/or other characteristics. Various filtering criteria may be applied.

Various app categories can be provided that can allow a user to narrow selections by category. In one embodiment, within a main screen area, various apps may be presented to the user. The user may be allowed to select one or more apps to utilize. In one embodiment, a user requests authorization before downloading the app. In other embodiments, the user may download the app and then request authorization, or the user may be allowed to download a trial version of the app, or the user may be allowed to use a limited version of the app.

In one embodiment, a software provider (e.g., ISV) can develop a software package in a development organization of a multitenant (or multi-organizational) environment. In one embodiment, after development, the software package is associated with a management organization that is responsible for provisioning the package. In one embodiment, the functionality and access to the package (or components of the package) are granted using license definitions having custom permissions that are specific to the package and managed by the management organization. In one embodiment, the software package is distributed via an app exchange as described above.

In one embodiment, the management organization associates the software packages with license definitions or other objects associated with the package that can be used for licensing in the manner described herein. In one embodiment, when a request is made for package installation, the app exchange initiates creation of an order on the management organization that targets the customer and provides the product associated with the package. In one embodiment, when the order is activated, provisioning triggers the package installation process and installation of the required permissions and/or licenses to the customer organization.

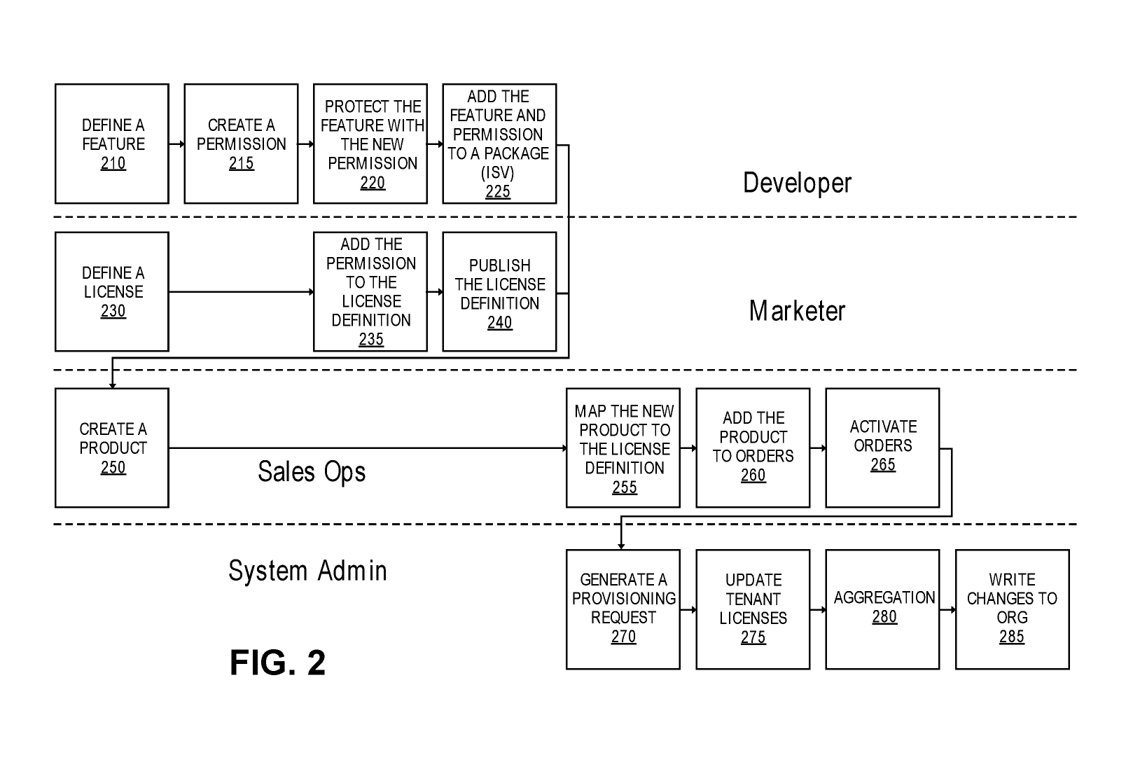

FIG. 2 is a conceptual illustration of one embodiment of a technique to provide licensing as a service. In one embodiment, the licensing service can be provided with a platform as a service (PaaS) environment. In general a PaaS is a cloud-based environment that allows users/organizations to develop, run and/or manage applications without maintaining their own infrastructure typically associated with developing and/or launching an app. PaaS can be provided from a provider where the users/organizations control software deployment and the provider provides hardware, middleware, operating systems, etc. Example PaaS providers include, for example, Heroku, IBM, Red Hat, AWS, Hewlett Packard. In one embodiment, the LaaS environment can provide license definitions to applications residing on disparate heterogeneous cloud environments.

In one embodiment, a developer defines one or more feature 210 to be included in and licensed as described herein. The developer also creates one or more permissions 215 to be associated with the feature(s). The association between the permission(s) and the features(s) protects the feature(s) 220 by controlling its usability. In one embodiment, the feature(s) and the permission(s) can be added to a software package 225.

In one embodiment, a marketing entity can create a license definition 230 to go with the software package. The permission(s) can be added to the license definition 235 by the marketing entity (or another entity). In one embodiment, the license definition is published 240, for example, by the marketing entity.

In one embodiment, the software package and the corresponding license definition can be combined to create/provide a product 250. In one embodiment, in a sales environment (e.g., app exchange), the product is mapped to the license definition 255. The product (with associated LDs) can be added to orders 260, for example, making the product available to users. Orders can then be activated 265.

In one embodiment, a system administration entity can generate a provisioning request 270 in response to an order. Tenant (or user) licenses are updated 275. License aggregation, if necessary, is performed 280 and changes are written to the appropriate environments (e.g., an organization/tenant within a multitenant environment) 285.

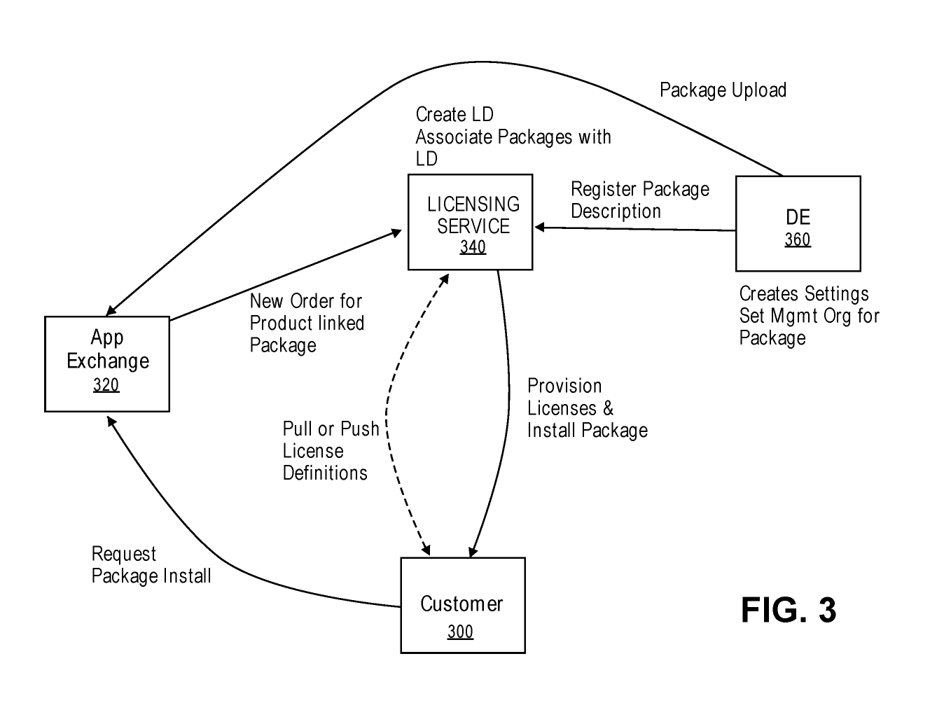

FIG. 3 is a conceptual illustration of one embodiment of a technique and architecture for supporting licensing as a service. Various components of FIG. 3 can be implemented by one or more hardware computing devices. For example, one or more of the components of FIG. 3 can be provided within a multitenant environment or other computing platform.

In one embodiment, a software developer can utilize development environment (DE) 360 to develop and/or test a software application package. Development environment 360 can represent a broad range of development environments. The software package can be uploaded to app exchange 320, which operates as described above. The software package is also registered with licensing service 340.

In one embodiment, licensing service 340 operates to manage a license definition (LD) to be associated with the software package (these license definitions can be created elsewhere, in the development environment or elsewhere, and registered with the management organization). In one embodiment, the license definition(s) include one or more custom permissions that can be utilized to authorize components of the software package.

In operation, customer 300 can access app exchange 320, for example, via a browser or other interface to acquire an app. In one embodiment, this includes requesting a package installation. In one embodiment, the app can be downloaded from app exchange 320 at that time, and then licenses/permissions can be acquired from licensing service 340. In another embodiment, the app can be downloaded after licenses/permissions are acquired from licensing service 340. In the example of FIG. 3, customer 300 represents an electronic device (e.g., smartphone, tablet, laptop, desktop, kiosk, wearable computing device) that a customer utilizes to acquire the app.

In one embodiment, in response to the request from customer 300, app exchange 320 initiates an order for the package with licensing service 340. In response to the order, licensing service 340 provisions the appropriate license(s) and causes/allows customer 300 to install the package or use additional features within the package as allowed by the license. In one embodiment, one or more license definitions may be pushed from licensing service 340 to customer 300. In another embodiment, customer 300 may pull license definitions from management 240. In yet another embodiment, a combination of pushing license definitions and pulling license definitions can be supported.

In one embodiment, licensing service 340 operates to manage licenses granted to any number of customers. In one embodiment, licensing service 340 operates to update licenses to customer 300 to provide additional licenses for one or more modules of the previously installed package in response to a request or purchase by customer 300. Similarly, licenses for one or more modules can be revoked or modified in response to events (e.g., expiration) that occur after the package has been installed.

In one embodiment, license definitions can be bundled with the current version of the package, and the code along with the license definitions are deployed as a unit. In this embodiment, the license definitions are always current, but new releases and corresponding license definitions must be deployed together.

In one embodiment, licensing service 340 operates as a CSP source of truth and defines a per-CSP (alternatively, a per-ISV) source of truth for license definitions. This embodiment, allows each CSP/ISV to manage how their license definitions are stored and shared, and can provide restrictions on who can write to more limited repositories that store the license definitions.

In one embodiment, licensing service 340 operates a single source of global truth for licensing definitions. In this embodiment, license definitions are uploaded to a single global repository. All tenants from, for example, disparate heterogeneous cloud environments can refer to this global source of truth for relevant license definitions.

In this embodiment, a tenant from a multitenant environment is allowed to request the latest version of a license definition applicable to that tenant's environment (including the version of software that the tenant is currently running). Different tenants and/or different environments can have different license definitions.

In one embodiment, license definitions can be changed independent of the associated code, which can allow for improved synchronization. In one embodiment, initial license definitions automatically become trial definitions when they are create, which allows a customer/tenant to try a package before buying the package.

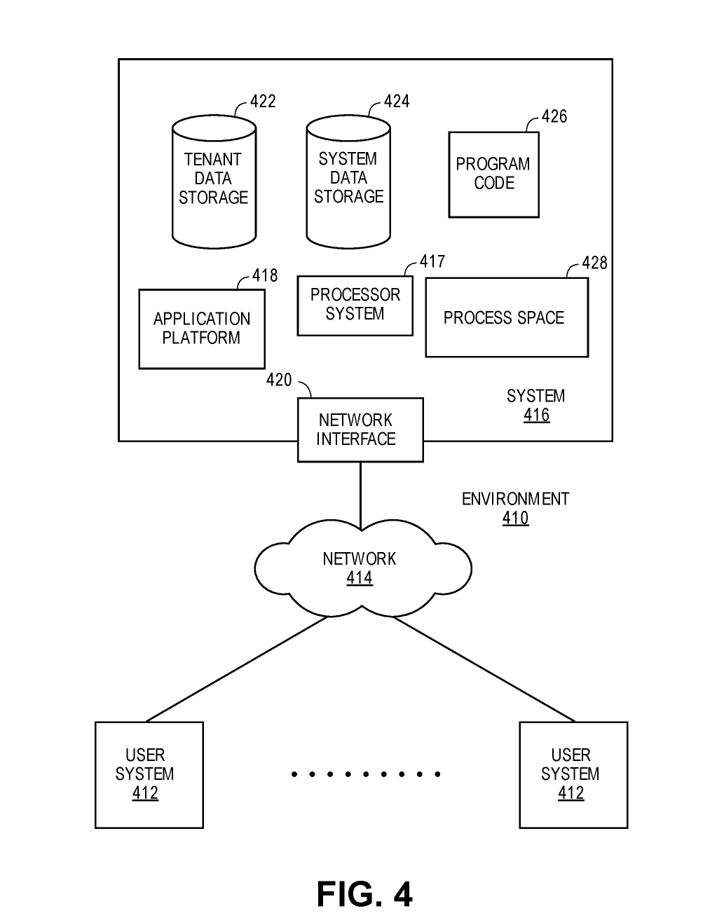

FIG. 4 illustrates a block diagram of an environment 410 wherein an on-demand database service might be used. Environment 410 may include user systems 412, network 414, system 416, processor system 417, application platform 418, network interface 420, tenant data storage 422, system data storage 424, program code 426, and process space 428. In other embodiments, environment 410 may not have all of the components listed and/or may have other elements instead of, or in addition to, those listed above.

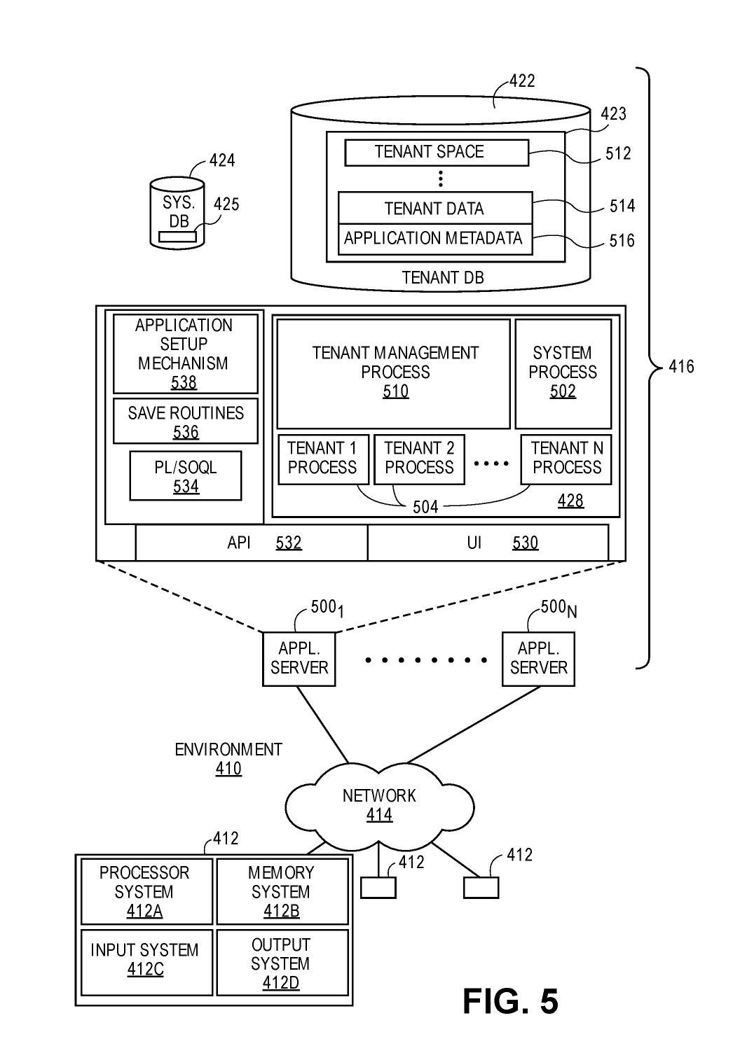

Environment 410 is an environment in which an on-demand database service exists. User system 412 may be any machine or system that is used by a user to access a database user system. For example, any of user systems 412 can be a handheld computing device, a mobile phone, a laptop computer, a work station, and/or a network of computing devices. As illustrated in herein FIG. 4 (and in more detail in FIG. 5) user systems 412 might interact via a network 414 with an on-demand database service, which is system 416.

An on-demand database service, such as system 416, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 416” and “system 416” will be used interchangeably herein. A database image may include one or more database objects. A relational database management system (RDMS) or the equivalent may execute storage and retrieval of information against the database object(s). Application platform 418 may be a framework that allows the applications of system 416 to run, such as the hardware and/or software, e.g., the operating system. In an embodiment, on-demand database service 416 may include an application platform 418 that enables creation, managing and executing one or more applications developed by the provider of the on-demand database service, users accessing the on-demand database service via user systems 412, or third party application developers accessing the on-demand database service via user systems 412.

The users of user systems 412 may differ in their respective capacities, and the capacity of a particular user system 412 might be entirely determined by permissions (permission levels) for the current user. For example, where a salesperson is using a particular user system 412 to interact with system 416, that user system has the capacities allotted to that salesperson. However, while an administrator is using that user system to interact with system 416, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 414 is any network or combination of networks of devices that communicate with one another. For example, network 414 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 412 might communicate with system 416 using TCP/IP and, at a higher network level, use other common Internet protocols to communicate, such as HTTP, FTP, AFS, WAP, etc. In an example where HTTP is used, user system 412 might include an HTTP client commonly referred to as a “browser” for sending and receiving HTTP messages to and from an HTTP server at system 416. Such an HTTP server might be implemented as the sole network interface between system 416 and network 414, but other techniques might be used as well or instead. In some implementations, the interface between system 416 and network 414 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 416, shown in FIG. 4, implements a web-based customer relationship management (CRM) system. For example, in one embodiment, system 416 includes application servers configured to implement and execute CRM software applications as well as provide related data, code, forms, webpages and other information to and from user systems 412 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 416 implements applications other than, or in addition to, a CRM application. For example, system 416 may provide tenant access to multiple hosted (standard and custom) applications, including a CRM application. User (or third party developer) applications, which may or may not include CRM, may be supported by the application platform 418, which manages creation, storage of the applications into one or more database objects and executing of the applications in a virtual machine in the process space of the system 416.

One arrangement for elements of system 416 is shown in FIG. 4, including a network interface 420, application platform 418, tenant data storage 422 for tenant data 423, system data storage 424 for system data 425 accessible to system 416 and possibly multiple tenants, program code 426 for implementing various functions of system 416, and a process space 428 for executing MTS system processes and tenant-specific processes, such as running applications as part of an application hosting service. Additional processes that may execute on system 416 include database indexing processes.

Several elements in the system shown in FIG. 4 include conventional, well-known elements that are explained only briefly here. For example, each user system 412 could include a desktop personal computer, workstation, laptop, PDA, cell phone, or any wireless access protocol (WAP) enabled device or any other computing device capable of interfacing directly or indirectly to the Internet or other network connection. User system 412 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 412 to access, process and view information, pages and applications available to it from system 416 over network 414. Each user system 412 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 416 or other systems or servers. For example, the user interface device can be used to access data and applications hosted by system 416, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 412 and all of its components are operator configurable using applications, such as a browser, including computer code run using a central processing unit such as an Intel Pentium® processor or the like. Similarly, system 416 (and additional instances of an MTS, where more than one is present) and all of their components might be operator configurable using application(s) including computer code to run using a central processing unit such as processor system 417, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 416 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 416 is configured to provide webpages, forms, applications, data and media content to user (client) systems 412 to support the access by user systems 412 as tenants of system 416. As such, system 416 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 5 also illustrates environment 410. However, in FIG. 5 elements of system 416 and various interconnections in an embodiment are further illustrated. FIG. 5 shows that user system 412 may include processor system 412A, memory system 412B, input system 412C, and output system 412D. FIG. 5 shows network 414 and system 416. FIG. 5 also shows that system 416 may include tenant data storage 422, tenant data 423, system data storage 424, system data 425, User Interface (UI) 530, Application Program Interface (API) 532, PL/SOQL 534, save routines 536, application setup mechanism 538, applications servers 500₁-500_{N}, system process space 502, tenant process spaces 504, tenant management process space 510, tenant storage area 512, user storage 514, and application metadata 516. In other embodiments, environment 410 may not have the same elements as those listed above and/or may have other elements instead of, or in addition to, those listed above.

User system 412, network 414, system 416, tenant data storage 422, and system data storage 424 were discussed above in FIG. 4. Regarding user system 412, processor system 412A may be any combination of one or more processors. Memory system 412B may be any combination of one or more memory devices, short term, and/or long term memory. Input system 412C may be any combination of input devices, such as one or more keyboards, mice, trackballs, scanners, cameras, and/or interfaces to networks. Output system 412D may be any combination of output devices, such as one or more monitors, printers, and/or interfaces to networks. As shown by FIG. 5, system 416 may include a network interface 420 (of FIG. 4) implemented as a set of HTTP application servers 500, an application platform 418, tenant data storage 422, and system data storage 424. Also shown is system process space 502, including individual tenant process spaces 504 and a tenant management process space 510. Each application server 500 may be configured to tenant data storage 422 and the tenant data 423 therein, and system data storage 424 and the system data 425 therein to serve requests of user systems 412. The tenant data 423 might be divided into individual tenant storage areas 512, which can be either a physical arrangement and/or a logical arrangement of data. Within each tenant storage area 512, user storage 514 and application metadata 516 might be similarly allocated for each user. For example, a copy of a user's most recently used (MRU) items might be stored to user storage 514. Similarly, a copy of MRU items for an entire organization that is a tenant might be stored to tenant storage area 512. A UI 530 provides a user interface and an API 532 provides an application programmer interface to system 416 resident processes to users and/or developers at user systems 412. The tenant data and the system data may be stored in various databases, such as one or more Oracle™ databases.

Application platform 418 includes an application setup mechanism 538 that supports application developers' creation and management of applications, which may be saved as metadata into tenant data storage 422 by save routines 536 for execution by subscribers as one or more tenant process spaces 504 managed by tenant management process 510 for example. Invocations to such applications may be coded using PL/SOQL 534 that provides a programming language style interface extension to API 532. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 516 for the subscriber making the invocation and executing the metadata as an application in a virtual machine.

Each application server 500 may be communicably coupled to database systems, e.g., having access to system data 425 and tenant data 423, via a different network connection. For example, one application server 500₁ might be coupled via the network 414 (e.g., the Internet), another application server 500_{N-1} might be coupled via a direct network link, and another application server 500_{N} might be coupled by yet a different network connection. Transfer Control Protocol and Internet Protocol (TCP/IP) are typical protocols for communicating between application servers 500 and the database system. However, it will be apparent to one skilled in the art that other transport protocols may be used to optimize the system depending on the network interconnect used.

In certain embodiments, each application server 500 is configured to handle requests for any user associated with any organization that is a tenant. Because it is desirable to be able to add and remove application servers from the server pool at any time for any reason, there is preferably no server affinity for a user and/or organization to a specific application server 500. In one embodiment, therefore, an interface system implementing a load balancing function (e.g., an F5 Big-IP load balancer) is communicably coupled between the application servers 500 and the user systems 412 to distribute requests to the application servers 500. In one embodiment, the load balancer uses a least connections algorithm to route user requests to the application servers 500. Other examples of load balancing algorithms, such as round robin and observed response time, also can be used. For example, in certain embodiments, three consecutive requests from the same user could hit three different application servers 500, and three requests from different users could hit the same application server 500. In this manner, system 416 is multi-tenant, wherein system 416 handles storage of, and access to, different objects, data and applications across disparate users and organizations.

As an example of storage, one tenant might be a company that employs a sales force where each salesperson uses system 416 to manage their sales process. Thus, a user might maintain contact data, leads data, customer follow-up data, performance data, goals and progress data, etc., all applicable to that user's personal sales process (e.g., in tenant data storage 422). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 416 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 416 might also maintain system level data usable by multiple tenants or other data. Such system level data might include industry reports, news, postings, and the like that are sharable among tenants.

In certain embodiments, user systems 412 (which may be client systems) communicate with application servers 500 to request and update system-level and tenant-level data from system 416 that may require sending one or more queries to tenant data storage 422 and/or system data storage 424. System 416 (e.g., an application server 500 in system 416) automatically generates one or more SQL statements (e.g., one or more SQL queries) that are designed to access the desired information. System data storage 424 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A non-transitory computer-readable medium having stored thereon instructions that, when executed by one or more processors, are configurable to cause the one or more processors to:
download a software package from the app exchange in response to a download request;
receive, from a licensing entity, one or more licenses to the client electronic device, wherein the one or more licenses are maintained by the licensing entity for tenants of disparate heterogeneous cloud environments and provide the client electronic device authorization to utilize the software package;
assign, the licenses received from the licensing entity, to one or more users within the client electronic device so that those users are granted access to the corresponding package;
utilize, with the client electronic device, the software package with the one or more licenses as authorization.

2. The non-transitory computer-readable medium of claim 1 wherein the disparate heterogeneous cloud environments comprise at least one multitenant environment.

3. The non-transitory computer-readable medium of claim 1 wherein the disparate heterogeneous cloud environments are provided by at least two different providers.

4. The non-transitory computer-readable medium of claim 1 wherein the client electronic device comprises a mobile computing device.

5. The non-transitory computer-readable medium of claim 1 wherein the disparate heterogeneous cloud environments comprise at least one platform as a service (PaaS) that allows users/organizations to develop, run and/or manage applications without maintaining their own infrastructure.

6. The non-transitory computer-readable medium of claim 1 wherein each license comprises one or more license definitions (LDs) that include one or more custom permissions that can be utilized to authorize components of the corresponding software package.

7. A method comprising:
downloading a software package from the app exchange in response to a download request;
receiving, from a licensing entity, one or more licenses to the client electronic device, wherein the one or more licenses are maintained by the licensing entity for tenants of disparate heterogeneous cloud environments and provide the client electronic device authorization to utilize the software package;
assigning, the licenses received from the licensing entity, to one or more users within the client electronic device so that those users are granted access to the corresponding package;
utilizing, with the client electronic device, the software package with the one or more licenses as authorization.

8. The method of claim 7 wherein the disparate heterogeneous cloud environments comprise at least one multitenant environment.

9. The method of claim 7 wherein the disparate heterogeneous cloud environments are provided by at least two different providers.

10. The method of claim 7 wherein the client electronic device comprises a mobile computing device.

11. The method of claim 7 wherein the disparate heterogeneous cloud environments comprise at least one platform as a service (PaaS) that allows users/organizations to develop, run and/or manage applications without maintaining their own infrastructure.

12. The method of claim 7 wherein each license comprises one or more license definitions (LDs) that include one or more custom permissions that can be utilized to authorize components of the corresponding software package.

13. A system comprising:
at least one memory device;
one or more processors coupled with the at least one memory device, the one or more processors configurable to download a software package from the app exchange in response to a download request, to receive, from a licensing entity, one or more licenses to the client electronic device, wherein the one or more licenses are maintained by the licensing entity for tenants of disparate heterogeneous cloud environments and provide the client electronic device authorization to utilize the software package, to assign, the licenses received from the licensing entity, to one or more users within the client electronic device so that those users are granted access to the corresponding package, and to utilize, with the client electronic device, the software package with the one or more licenses as authorization.

14. The system of claim 13 wherein the disparate heterogeneous cloud environments comprise at least one multitenant environment.

15. The system of claim 13 wherein the disparate heterogeneous cloud environments are provided by at least two different providers.

16. The system of claim 13 wherein the client electronic device comprises a mobile computing device.

17. The system of claim 13 wherein the disparate heterogeneous cloud environments comprise at least one platform as a service (PaaS) that allows users/organizations to develop, run and/or manage applications without maintaining their own infrastructure.

18. The system of claim 13 wherein each license comprises one or more license definitions (LDs) that include one or more custom permissions that can be utilized to authorize components of the corresponding software package.
